(19) United States
(12) Patent Application Publication
(10) Pub. No.: US 2026/0317529 A1
(43) Pub. Date: Oct. 15, 2026

(54) Composite Material for Microstrip Antenna Substrate, Preparation Method Therefor and Use Thereof

(71) Applicant: Zhejiang University of Technology, Hangzhou City (CN)

(72) Inventors: Juan LI, Hangzhou City (CN); Zidong ZHAO, Hangzhou City (CN); Shenglei CHE, Hangzhou City (CN); Jing YU, Hangzhou City (CN); Jingwu ZHENG, Hangzhou City (CN); Liang QIAO, Hangzhou City (CN); Yao YING, Hangzhou City (CN); Wangchang LI, Hangzhou City (CN)

(21) Appl. No.: 19/175,320

(22) Filed: Apr. 10, 2025

(51) Int. Cl. C08L 33/12; C01G 51/66; C08J 3/20; C08K 3/22; H01F 1/34; H01Q 9/04

(52) U.S. Cl. CPC C08L 33/12; C01G 51/66; C08J 3/203; C08K 3/22; H01Q 9/0407; C01P 2006/42; C08J 2333/12; C08J 2429/04; C08K 2003/2289; C08K 2201/01; C08L 2203/20; C08L 2205/18; H01F 1/348

(57) ABSTRACT

Disclosed are a composite material for a microstrip antenna substrate, a preparation method and use thereof. The composite material is compounded by 40% to 60% by mass of a Co₂ Y-type hexagonal ferrite as a main phase, and 40% to 60% by mass of polymethyl methacrylate (PMMA)plexiglass microspheres having a particle size of 1 μm to 2 μm as an auxiliary material. The method includes: 1) preparing raw materials, mixing by a first ball milling, and drying; 2) pre-sintering; 3) conducting a second ball milling, and drying; and 4) mixing materials in a mortar in proportion, adding 20% of polyvinyl alcohol (PVA) and then pressing into rings, and bonding at a temperature of 180 °C to 220 °C

### TECHNICAL FIELD

The present disclosure belongs to the technical field of electronic communication, and in particular relates to a composite material for a microstrip antenna substrate in Global Positioning System (GPS) and bluetooth frequency bands, and a preparation method thereof.

### BACKGROUND

With the development of electronic communication technology, the requirements for electronic components are increasing. Antenna, an indispensable and essential component in electronic communication, is increasingly demanded to be high-frequency and miniaturized. However, conventional antennas are used for a low-frequency band and have a large size, which could not meet the need of today's communication technology. Microstrip patch antennas have the characteristics of light weight, small size, and a high application frequency band, making them highly promising and valuable for practical applications.

There are two methods to reduce the size of the microstrip patch antenna. One is to increase the permeability of the antenna substrate materials. However, increasing the permeability leads to an increase in the magnetic losses of the antenna substrate, and the high losses are detrimental to reducing the return loss of the antenna, causing severe energy losses during the use of the antenna. The lost energy will dissipate in the form of heat, so high-loss antennas not only have a negative impact on the radiation efficiency of electromagnetic waves, but also cause certain damage to the use of the antenna itself due to serious heat generation. Another method is to increase the dielectric constant of the substrate materials. However, a high dielectric constant tends to result in charge accumulation within the substrate, which makes the electric field within the substrate extremely strong in a region, such that the electromagnetic waves radiate only in that region, adversely affecting the impedance matching factor (μ′/ε′) of the antenna and thus the radiating efficiency of the antenna. Therefore, making the substrate materials of the microstrip patch antenna have suitable permeability and low dielectric constant is beneficial to improving the bandwidth of low return loss and the radiative efficiency of the antenna.

Materials with excellent impedance matching characteristics, and low magnetic dielectric loss in higher frequency bands are of great significance to be applied to antenna substrates. In addition to the excellent magnetic dielectric properties of the materials themselves, the preparation process and the cost of the raw materials themselves should also be considered. So far, according to relevant research reports at home and abroad, Wang Tao, Xu Zhibiao, et al, from Lanzhou University have mainly used Co—Ti co-doped M-type hexagonal ferrite and Co₂W hexagonal ferrite, and Bi₂O₃ as an additive to reduce the sintering temperature of the materials mentioned above to modify their magnetic dielectric properties and application in microstrip antennas. Wang Shizhang, Nie Yan, et al., from Huazhong University of Science and Technology studied the effect of the preparation process on the magnetic dielectric properties of the hexagonal ferrite having both Y+ Z phases and its use in antennas. As published in October 2015, Shigeo Fujii, Koji Wakamatsu, Hiroshi Satoh, and Setsuo Yamamoto, et al., from Yamaguchi University in Japan used Co₂Y, with CuO added to improve the bandwidth thereof when used in the antenna. However, whether ion doping or by addition of other additives, all the materials are suitable for frequencies below 1 GHz, the preparation process thereof is complex, and the costs of raw materials are high.

### SUMMARY

In view of the drawbacks in the prior art, the present disclosure provides a composite material for a microstrip antenna substrate, a preparation method and use thereof.

A first aspect of the present disclosure provides a composite material for a microstrip antenna substrate, wherein the composite material is compounded by 40% to 60% by mass of a Co₂Y powder and 40% to 60% by mass of polymethyl methacrylate (PMMA) plexiglass microspheres.

In some embodiments, Co₂Y has a molecular formula of Ba₂Co₂Fe₁₂O₂₂, and the PMMA plexiglass microspheres have a particle size of 1 μm to 2 μm.

In some embodiments, the Co₂Y powder and the PMMA plexiglass microspheres are mixed by a solid phase process and then compounded by bonding at a temperature of 180 °C to 220 °C

In some embodiments, the bonding is conducted in a muffle furnace with a heating rate of 5 °C/min and a holding time of 30 min.

In some embodiments, the composite material further includes 20% by mass of polyvinyl alcohol (PVA).

A second aspect of the present disclosure provides a method for preparing the composite material for a microstrip antenna substrate, including:
step 1: using Ba₂CO₃, CO₃O₄, and Fe₂O₃ as raw materials, and placing the raw materials into a ball mill tank at a ratio according to a chemical formula of Ba₂Co₂Fe₁₂O₂₂; and adding deionized water and ball-milling beads to the ball mill tank and conducting ball milling for a certain time to mix evenly, and drying to obtain a dried material;
step 2: placing the dried material in a crucible, and pre-sintering by using a box furnace to obtain a Co₂Y powder, cooling the Co₂Y powder to room temperature and taking out to obtain a pre-sintered powder;
step 3: mixing the pre-sintered powder obtained in step 3, deionized water and ball-milling beads and conducting a second ball milling for a certain time, and then drying; and
step 4: mixing 40% to 60% by mass of a resulting Co₂Y power after the second ball milling and 40% to 60% by mass of PMMA plexiglass microspheres by a solid phase process; and then adding PVA, pressing a resulting mixture into rings, and then bonding by using a muffle furnace at a temperature of 180 °C to 220 °C, and then cooling with the muffle furnace to obtain the composite material.

In some embodiments, in step 1, a ratio of the raw materials, the deionized water and the ball-milling beads is 1:1:3; and in step 3, a ratio of the pre-sintered powder, the deionized water and the ball-milling beads is 1:1:3.

A third aspect of the present disclosure provides a microstrip antenna, including a substrate using the composite material prepared by the method as described above.

A fourth aspect of the present disclosure provides the use of the microstrip antenna in GPS and Bluetooth frequency bands.

Embodiments of the present disclosure have the following beneficial effects:

In the present disclosure, low-temperature bonded Y-type planar hexagonal ferrite (Ba₂Co₂Fe₁₂O₂₂) is used. By introducing a non-magnetic second phase and a low dielectric auxiliary material (PMMA plexiglass microspheres) and controlling the grain size of the magnetic material using low-temperature bonding, grain growth during sintering could be avoided, and the temperature of material preparation could also be greatly reduced, thereby effectively reducing the costs of material preparation.

The softening of the non-magnetic phase in the composite material affects the structure of the composite material to some extent. The non-magnetic phase is filled in the grain boundaries, which effectively increases the resistance to domain wall displacement, reduces the resistance caused by the wall displacement magnetization mechanism, improves the magnetic quality factor of the composite material, and reduces the dielectric constant of the composite material, thereby improving the gain of the microstrip antenna substrate and reducing the return loss of the substrate.

The composite material according to the present disclosure has a simple preparation process, a short preparation cycle, easily available raw materials, and thus low preparation costs, which is beneficial to mastering and popularizing.

### BRIEF DESCRIPTION OF THE DRAWINGS

FIG. 1 shows a schematic flow diagram of a method for preparing a composite material for a microstrip patch antenna substrate provided by an example of the present disclosure.

FIG. 2A shows the 3D gain plot of the antenna simulated by the composite material according to an embodiment of the present disclosure; FIG. 2B shows the performance parameters of the antenna in FIG. 2A; FIG. 2C shows the 3D gain plot of the antenna simulated by using an existing material in the simulation software; and FIG. 2D shows the performance parameters of the antenna in FIG. 2C.

FIG. 3 shows the complex permeability and magnetic loss of the composite material in an example of the present disclosure that are measured in the 1 M-1 GHz frequency bands.

FIG. 4 shows the complex permeability and magnetic loss of the composite material in an example of the present disclosure in the 1 GHz-12 GHz frequency bands.

FIG. 5 shows the dielectric constant and dielectric loss of the composite material in an example of the present disclosure in the 1 GHz-12 GHz frequency bands.

### DETAILED DESCRIPTION OF THE EMBODIMENTS

The technical solutions of the present disclosure are further illustrated through the following specific embodiments in conjunction with the accompanying drawings.

An embodiment of the present disclosure discloses a low-cost composite material for a microstrip patch antenna applied to GPS and Bluetooth, which is composed of 40% to 60% by mass of a Co₂Y powder and 60% to 40% of PMMA plexiglass microspheres. Co₂Y has a molecular formula of Ba₂Co₂Fe₁₂O₂₂, and the PMMA plexiglass microspheres are commercially available PMMA microspheres having a particle size of 1 μm to 2 μm.

The composite material is a new material that is compounded by two phases: a hexagonal ferrite and an organic polymer material. The organic polymer material has a permeability close to 1 and almost no magnetic loss. After compounding, it is located at the grain boundary of Co₂Y, which could not only reduce the loss caused by the domain rotation magnetization mechanism but also increase the damping coefficient at the grain boundary to suppress the magnetic loss caused by the wall displacement magnetization mechanism. The composite material has a magnetic loss of less than 0.01 within in the frequency range of 1 MHz to 1 GHz, a magnetic loss maintained at about 0.03 at the frequencies of 1.561 GHz and 2.45 GHz, and a dielectric loss of about 0.02, which could be applied to GPS and Bluetooth frequency bands.

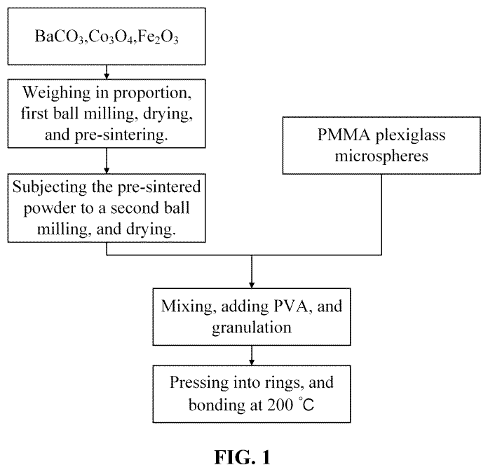

An embodiment according to the present disclosure further discloses a method for preparing the composite material for a microstrip patch antenna substrate as described above. As shown in FIG. 1, the method includes the following steps:
Step 1: Ba₂CO₃, CO₃O₄, and Fe₂O₃ are used as raw materials and placed into a ball mill tank at a ratio according to the chemical formula of Ba₂CO₂Fe₁₂O₂₂. The raw materials, deionized water and ball-milling beads are added to the ball mill tank at a mass ratio of 1:1:3. A resulting material is subjected to a first ball milling for 4 h to mix evenly, and a resulting mixture is then dried to obtain a dried material
Step 2: the dried material is placed in a crucible, subjected to pre-sintering by using a box furnace at 1050 °C, with a heating rate of 5 °C/min and a holding time of 2 h, to obtain a Co 2Y powder. Then the Co₂Y powder is cooled to 700 °C at a cooling rate of 5 °C/min, and then cooled with the furnace to room temperature, and then a resulting powder is taken out to obtain a pre-sintered powder.
Step 3: deionized water and zirconia ball milling beads and the pre-sintered powder are mixed at a mass ratio of 1:1:3. An obtained mixture is subjected to a second ball milling for 3 h, and then drying.
Step 4:40% to 60% by mass of a resulting powder after the second ball milling in step 3 is mixed with 40% to 60% by mass of PMMA by a conventional solid phase process, 20% of PVA is added. A resulting material is pressed into rings, then subjected to bonding in a muffle furnace at a temperature of 180 °C to 220 °C to obtain the composite material, with a heating rate of 5 °C/min and a holding time of 30 min.

In some embodiments, the composite material is prepared by mixing the pre-sintered Co₂Y powder with PMMA having a particle size of 1 μm to 2 μm by a solid phase process, which only requires bonding at the temperature of 180 °C to 220 °C. Compared to similar ferrite materials used in antenna substrates, the composite material according to the present disclosure has a low preparation temperature, a simple preparation method, a shorter preparation process, and easy availability.

In the above method, the Co₂Y and PMMA powders are mixed by a conventional solid phase process. In the laboratory, only a mortar is used for mixing, and the experimenter might decide to use other equipment for mixing according to the desired amount of the composite powder. When bonding samples, the temperature would vary due to different types of muffle furnaces, but the magnetic dielectric properties of the composite materials could also be obtained by bonding samples according to the temperature range as described above.

### Example 1

A method for preparing a composite material for a microstrip antenna substrate was conducted by the following steps:
Step 1: BaCO₃, Co₃O₄, and Fe₂O₃ were used as raw materials, and proportions of the raw materials were converted according to the proportion of each element in a Co₂Y molecule as mentioned above. The raw materials were weighed according to the proportions, and then placed into a ball mill tank. The raw materials, deionized water and zirconia ball milling beads were added to the ball mill tank at a mass ratio of 1:1:3. The ball mill tank was placed into a planetary ball mill and a resulting material was subjected to a first ball milling for 4 h to mix evenly, and a resulting mixture was dried to obtain a dried material.
Step 2: the dried material obtained in step 1 was placed in a crucible, and subjected to pre-sintering by using a box furnace. The dried material was heated to 1050 °C at a heating rate of 5 °C/min, held at the 1050 °C for 2 h, then cooled to 700 °C at a cooling rate of 5 °C/min, and then cooled with the box furnace to room temperature, and a resulting material was taken out to obtain a pre-sintered Co₂Y powder.

Step 3: the pre-sintered Co₂Y powder obtained in step 2, deionized water and zirconia ball milling beads were added into a ball mill tank at a mass ratio of 1:1:3. An obtained mixture was subjected to a second ball milling for 3 h, and then drying to obtain a Co₂Y powder after the second ball milling.

Step 4:40% to 60% by mass of the Co₂Y powder after the second ball milling in step 3 was mixed with 40% to 60% by mass of PMMA having a particle size of 1 μm to 2 μm by a conventional solid phase process, 20% of PVA was added. A resulting mixture was pressed into rings, then subjected to bonding in a muffle furnace at a temperature of 180 °C to 220 °C to obtain the composite material, with a heating rate of 5 °C/min and a holding time of 30 min.

### Example 2

A method for preparing a composite material for a microstrip antenna substrate was conducted by the following steps:
Step 1: BaCO₃, Co₃O₄, and Fe₂O₃ were used as raw materials, and proportions of the raw materials were converted according to the proportion of each element in a Co₂Y molecule as mentioned above. The raw materials were weighed according to the proportions, and then placed into a ball mill tank. The raw materials, deionized water and zirconia ball milling beads were added to the ball mill tank at a mass ratio of 1:1:3. The ball mill tank was placed into a planetary ball mill and a resulting material was subjected to a first ball milling for 4 h to mix evenly, and a resulting mixture was dried to obtain a dried material.
Step 2: the dried material obtained in step 1 was placed in a crucible, and subjected to pre-sintering by using a box furnace. The dried material was heated to 1050 °C at a heating rate of 5 °C/min, held at the 1050 °C for 2 h, then cooled to 700 °C at a cooling rate of 5 °C/min, and then cooled with the furnace to room temperature, and a resulting material was taken out to obtain a pre-sintered Co₂Y powder.

Step 3: the pre-sintered Co₂Y powder obtained in step 2, deionized water and zirconia ball milling beads were added into a ball mill tank at a mass ratio of 1:1:3. An obtained mixture was subjected to a second ball milling for 3 h, and then drying to obtain a Co₂Y powder after the second ball milling.

Step 4:40% to 60% by mass of the Co₂Y powder after the second ball milling in step 3 was mixed with 40% to 60% by mass of PMMA by a conventional solid phase process, 20% of PVA was added. A resulting mixture was pressed into rings, then subjected to bonding in a muffle furnace at a temperature of 190 °C to 210 °C to obtain the composite material, with a heating rate of 5 °C/min and a holding time of 30 min.

### Example 3

A method for preparing a composite material for a microstrip antenna substrate was conducted by the following steps:
Step 1: BaCO₃, Co₃O₄, and Fe₂O₃ were used as raw materials, and proportions of the raw materials were converted according to the proportion of each element in a Co₂Y molecule as mentioned above. The raw materials were weighed according to the proportions, and then placed into a ball mill tank. The raw materials, deionized water and zirconia ball milling beads were added to the ball mill tank at a mass ratio of 1:1:3. The ball mill tank was placed into a planetary ball mill and a resulting material was subjected to a first ball milling for 4 h to mix evenly, and a resulting mixture was dried to obtain a dried material.
Step 2: the dried material obtained in step 1 was placed in a crucible, and subjected to pre-sintering by using a box furnace. The dried material was heated to 1050 °C at a heating rate of 5 °C/min, held at the 1050 °C for 2 h, then cooled to 700 °C at a cooling rate of 5 °C/min, and then cooled with the furnace to room temperature, and a resulting material was taken out to obtain a pre-sintered Co₂Y powder.

Step 3: the pre-sintered Co₂Y powder obtained in step 2, deionized water and zirconia ball milling beads were added into a ball mill tank at a mass ratio of 1:1:3. An obtained mixture was subjected to a second ball milling for 3 h, and then drying to obtain a Co₂ Y powder after the second ball milling.

Step 4:40% to 60% by mass of the Co₂Y powder after the second ball milling in step 3 was mixed with 40% to 60% by mass of PMMA by a conventional solid phase process, 20% of PVA was added. A resulting mixture was pressed into rings, then subjected to bonding in a muffle furnace at a temperature of 195 °C to 205 °C to obtain the composite material, with a heating rate of 5 °C/min and a holding time of 30 min.

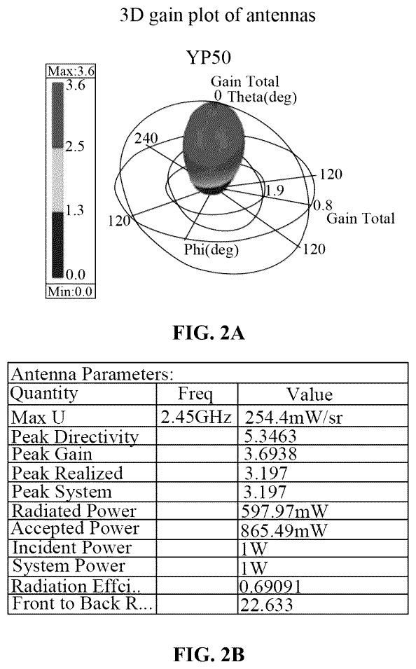

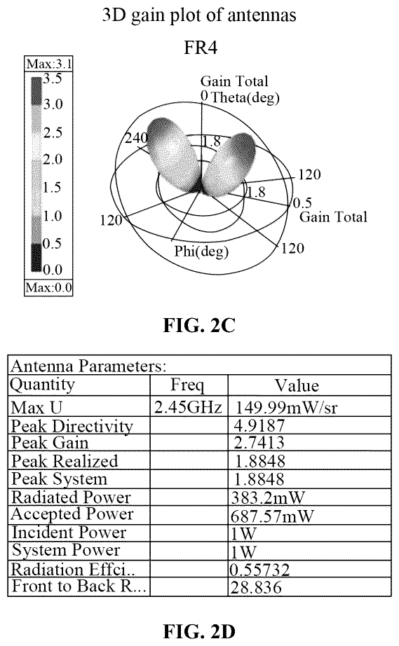

An embodiment of the present disclosure further discloses a microstrip antenna, including a substrate, where the composite material obtained by the method described above is used as the substrate. The antenna size is calculated according to an equation using HFSS simulation software to design an antenna substrate model. With the existing complex permeability and tangent of magnetic loss angle input, the impedance matching factor of the simulated antenna substrate is obtained through the antenna substrate model. The impedance matching factor and the size parameters can be used to simulate the 3D gain plot and the performance parameters of the antenna substrate. As shown in FIG. 2A to FIG. 2D, FR4 shows the 3D gain plot and the performance parameters of the antenna simulated by using an existing material in the simulation software, and YP50 shows the 3D gain plot and the performance parameters of the antenna simulated by the composite material according to this embodiment. Among the parameters, Max U is the maximum radiation intensity, Peak Directivity is the directivity coefficient, Peak Gain is the maximum gain, and Radiation Efficiency is the radiation efficiency. Compared with the antenna substrate simulated using the existing material FR4, the antenna substrate simulated using the performance parameters of the composite material according to this embodiment has a size that is reduced to approximately 49% of the original size, a maximum radiation intensity increased from 150 mW/sr to 254.4 mW/sr, a maximum gain increases from 2.74 to 3.69, and a radiation efficiency increases from 55.7% to 69%.

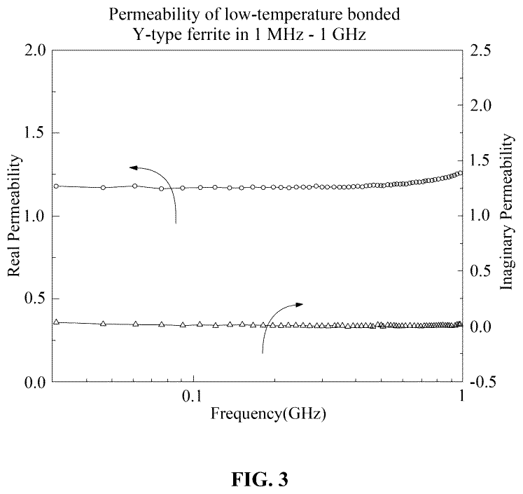

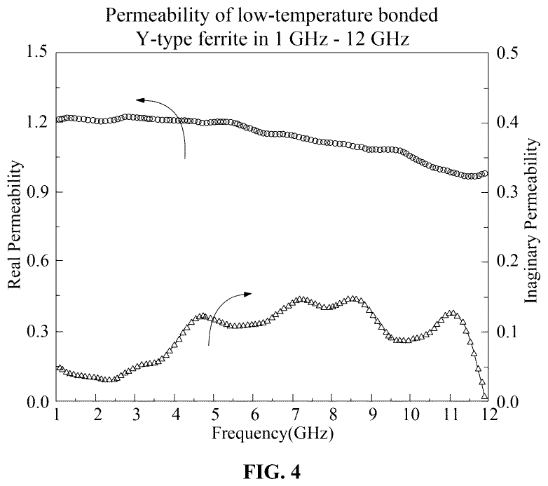

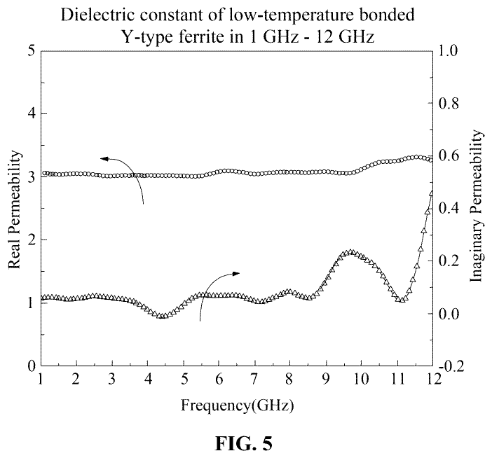

An embodiment of the present disclosure further discloses the use of the microstrip antenna as described above in GPS and Bluetooth frequency bands, as shown in FIGS. 3, 4, and 5. The material has a permeability of about 1.2 in the range of 1 M-1 GHz, and a stable permeability of about 1.2 and a dielectric constant of about 3 in the frequency bands required by GPS and Bluetooth. In the range of 1 M-1 GHz, the tangent of the magnetic loss angle is less than 0.01, and in the GPS frequency band (1.561 GHz), the material has a tangent of the magnetic loss angle of about 0.03 and a dielectric loss of less than 0.02. In the frequency band required by Bluetooth (2.45 GHz), the material has a tangent of the magnetic loss angle of about 0.025, and a tangent of the dielectric loss angle of about 0.02.

In summary, the composite material is used as the substrate for microstrip patch antennas, which could not only reduce the size and weight of the microstrip antenna substrate, but also increase the radiation efficiency, maximum radiation intensity, and maximum gain of the antenna substrate. In addition, the composite material is prepared by a low-temperature bonding method, with a simple preparation process, a short preparation period, easily available raw materials, and low preparation costs, which is easy to master and is beneficial to production and popularization.

What is claimed is:

1. A composite material for a microstrip antenna substrate, wherein the composite material is compounded by 40% to 60% by mass of a Co₂Y powder and 40% to 60% by mass of polymethyl methacrylate (PMMA) plexiglass microspheres.

2. The composite material for the microstrip antenna substrate of claim 1, wherein Co₂Y has a molecular formula of Ba₂Co₂Fe₁₂O₂₂, and the PMMA plexiglass microspheres each have a particle size of 1 μm to 2 μm.

3. The composite material for the microstrip antenna substrate of claim 1, wherein the Co₂Y powder and the PMMA plexiglass microspheres are mixed by a solid phase process and then compounded by bonding at a temperature of 180 °C to 220 °C.

4. The composite material for the microstrip antenna substrate of claim 3, wherein the bonding is conducted in a muffle furnace, with a heating rate of 5 °C/min and a holding time of 30 min.

5. The composite material for the microstrip antenna substrate of claim 4, wherein polyvinyl alcohol (PVA) is added into the composite material in an amount of 20% of a mass of the composite material.

6. A method for preparing a composite material for a microstrip antenna substrate, comprising:
step 1: using Ba₂CO₃, CO₃O₄, and Fe₂O₃ as raw materials, and placing the raw materials into a ball mill tank at a ratio according to a chemical formula of Ba₂Co₂Fe₁₂O₂₂; and adding a first deionized water and first ball-milling beads to the ball mill tank and conducting a first ball milling to mix, and drying to obtain a dried material;
step 2: placing the dried material in a crucible and pre-sintering by using a box furnace to obtain a Co₂Y powder, cooling the Co₂Y powder to room temperature and taking out to obtain a pre-sintered powder;
step 3: mixing the pre-sintered powder obtained in step 2, a second deionized water and second ball-milling beads and conducting a second ball milling, and then drying; and
step 4: mixing 40% to 60% by mass of a resulting Co₂Y powder after the second ball milling and 40% to 60% by mass of PMMA plexiglass microspheres by a solid phase process; and then adding PVA, pressing a resulting mixture into rings, and then bonding by using a muffle furnace at a temperature of 180 °C to 220 °C, and then cooling with the muffle furnace to obtain the composite material.

7. The method for preparing the composite material for the microstrip antenna substrate of claim 6, wherein in step 1, a mass ratio of the raw materials, the first deionized water and the first ball-milling beads is 1:1:3; and
in step 3, a ratio of the pre-sintered powder, the second deionized water and the second ball-milling beads is 1:1:3.

8. A microstrip antenna, comprising a substrate, wherein the composite material prepared by the method of claim 6 is used as the substrate.

9. A microstrip antenna, comprising a substrate, wherein the composite material prepared by the method of claim 7 is used as the substrate.

10. A microstrip antenna, comprising the composite material of claim 1 as a substrate.
